(19) United States
(12) Patent Application Publication
(10) Pub. No.: US 2010/0031898 A1
(43) Pub. Date: Feb. 11, 2010

(54) Apparatus for Use in Dressing a Wound or Surgical Site on an Animal

(76) Inventor: Angela June Page, Hertfordshire (GB)

Correspondence Address: Thomas M. Galgano, 20 W. Park Avenue, Suite 204, Long Beach, NY, 11561, US

(21) Appl. No.: 12/085,558

(22) PCT Filed: Nov. 27, 2006
(86) PCT No.: PCT/GB2006/004409

§ 371 Date: Oct. 15, 2009

(30) Foreign Application Priority Data
Nov. 25, 2005 (GB) 0524018.9

(51) Int. Cl. A61D 9/00

(52) U.S. Cl. 119/850

(57) ABSTRACT

Apparatus for use in dressing a wound or surgical site on an animal, said apparatus comprising: a cover part for covering the wound or surgical site; and one or more straps that are integral with or attachable to the cover part and which are adapted to be secured around another part of the animal's body. Also provided is a method of covering a wound or surgical site on an animal, said method comprising: applying a cover to the wound or surgical site; and fastening one or more straps around another part of the animal's body, said one or more straps being attached to the cover.

The present invention relates to veterinary dressings and associated apparatus for animals that have been wounded or injured, or which have been operated upon by a veterinary surgeon. The invention is particularly applicable, but by no means limited, for use with domestic pets such as dogs and cats, horses, zoo animals, farm animals such as cows, sheep and pigs, and other four-legged animals.

It is well known that animals sometimes become wounded or injured, or suffer from some other ailment, and consequently require treatment by a veterinary surgeon. For example, a cat may be injured by a motor vehicle, and may consequently require surgery. A dog may gash its leg against a sharp object. Animals such as cats and zoo animals may also become wounded through fighting with each other. Bites from other animals can result in open wounds which can become infected if untreated. Often a veterinary surgeon will stitch up a surgical site or wound, although in some cases a wound may be left unstitched.

It is common for a veterinary surgeon to apply a dressing over stitches, or over an unstitched wound. The purpose of such a dressing is generally to apply medication to the wound or surgical site in order to aid the healing process, to keep the wound or surgical site clean, and to stop it from becoming infected.

However, a problem experienced by many veterinary surgeons and animal owners is that the animal has a tendency to fidget with the dressing, and is often able to remove a conventional dressing relatively easily using its teeth and legs. In other cases, the dressing may work its way off as a result of the animal's natural motion. There is therefore a desire to be able to attach dressings more securely to animals.

According to a first aspect of the present invention there is provided apparatus for use in dressing a wound or surgical site on an animal, said apparatus comprising: a cover part for covering the wound or surgical site; and one or more straps that are integral with or attachable to the cover part and which are adapted to be secured around another part of the animal's body.

The one or more straps adapted to be secured around another part of the animal's body advantageously enable the dressing to be attached to the animal more securely than has conventionally been possible. Thus, the animal is prevented (or at least impeded) from readily removing the cover part, and this in turn assists the healing process since the wound or surgical site can be kept dressed or otherwise covered for longer.

The term “surgical site” as used herein should be interpreted broadly, to include the animal's anus and genitourinary region if the animal is suffering from incontinence and the apparatus is being used to contain urine or excrement.

The cover part may be a dressing. Alternatively the cover part may be a cover for a dressing.

The term “dressing” as used herein should be interpreted broadly, to encompass not only surgical and medical dressings for animals, but also incontinence pads (or animal nappies or diapers), surgical supports and other surgical or medical articles that may be fitted to an animal.

In an embodiment in which the cover part is a cover for a dressing, preferably the cover for the dressing comprises a first region for receiving a dressing and a first hole for one or more of the animal's legs to pass through.

Preferably the cover for the dressing is made of a textile material.

Preferably the cover for the dressing is manipulable from an open configuration in which a dressing may be introduced to the first region and in which the first hole is to one side of the first region, to a closed configuration in which the first region overlaps the first hole. In use, this facilitates the introduction of the dressing into the cover, and the application of the dressing and cover to the animal.

Preferably the cover for the dressing further comprises one or more fasteners for securing the cover in the closed configuration. The fasteners may comprise one or more strips of hook-and-loop fasteners (e.g. Velcro®). Alternative fastening means, such as press fasteners or zips, may however be used instead, as those skilled in the art will appreciate.

Preferably the cover for the dressing incorporates a fold line about which the cover may be folded from the open configuration to the closed configuration.

Preferably the cover for the dressing further comprises a second hole for the animal's tail to pass through. The fold line may pass through or close to the second hole.

Preferably the cover for the dressing is adapted to hold the dressing on the rear part of the animal's back.

With regard now to the one or more straps, preferably the apparatus comprises two straps.

Preferably the apparatus further comprises two crossover members through each of which both straps pass. Each crossover member serves to constrain the straps in a crosswise configuration. The crossover members may allow some sliding of the straps, but preferably the straps are gripped by the crossover members such that sliding of the straps can only be performed by a human when fitting the straps to the animal.

Preferably a first end of each strap is provided with fastening means for attachment to the cover part. Particularly preferably the fastening means are clips, although alternative fastening means such as press fasteners may be used instead.

Preferably a second end of each strap is provided with attachment means for attaching said end to said strap. Particularly preferably the attachment means comprises a loop formed in the end of the strap.

The straps may be configured to pass between the animal's front legs and over the animal's back, and thereby secure the cover part on the rear part of the animal's back.

Preferably the said straps are elasticated.

In another embodiment, the cover part comprises a sleeve, and preferably comprises a single strap. The sleeve may be used, for example, to cover a wound or a dressing on an animal's leg, and the strap advantageously makes it harder for the animal to remove the sleeve.

Preferably the strap is integral with the sleeve.

Preferably the end of the strap distal from the sleeve is provided with fastening means.

Preferably the cover part is provided with fastening means adapted to fasten with the fastening means provided on the distal end of the strap.

Preferably the apparatus is made of a textile material, which is particularly preferably elasticated.

According to a second aspect of the present invention there is provided a cover for a dressing for an animal, the cover comprising a first region for receiving a dressing and a first hole for one or more of the animal's legs to pass through.

Preferably the cover is made of a textile material.

Preferably the cover is manipulable from an open configuration in which a dressing may be introduced to the first region and in which the first hole is to one side of the first region, to a closed configuration in which the first region overlaps the first hole.

Preferably the cover further comprises one or more fasteners for securing the cover in the closed configuration.

Preferably the fasteners comprise one or more strips of hook-and-loop fasteners.

Preferably the cover incorporates a fold line about which the cover may be folded from the open configuration to the closed configuration.

Preferably the cover further comprises a second hole for the animal's tail to pass through.

The fold line may pass through or close to the second hole.

Preferably the cover is adapted to hold a dressing on the rear part of an animal's back.

The cover may be provided with a dressing pre-installed.

According to a third aspect of the present invention there is provided a harness for securing a dressing or a cover for a dressing to an animal's body.

Preferably the harness comprises two straps.

Preferably the harness further comprises two crossover members through each of which both straps pass.

Preferably a first end of each strap is provided with fastening means for attachment to a dressing or to a cover for a dressing. Particularly preferably the fastening means are clips, although alternative fastening means such as press fasteners may be used instead.

Preferably a second end of each strap is provided with attachment means for attaching said end to said strap. Particularly preferably the attachment means comprises a loop formed in the end of the strap.

The straps may be configured to pass between the animal's front legs and over the animal's back, and may thereby be used to secure a dressing or the cover for a dressing on the rear part of the animal's back.

Preferably the said straps are elasticated.

According to a fourth aspect of the present invention there is provided a method of covering a wound or surgical site on an animal, said method comprising: applying a cover to the wound or surgical site; and fastening one or more straps around another part of the animal's body, said one or more straps being attached to the cover.

Embodiments of the invention will now be described, by way of example, and with reference to the drawings in which:

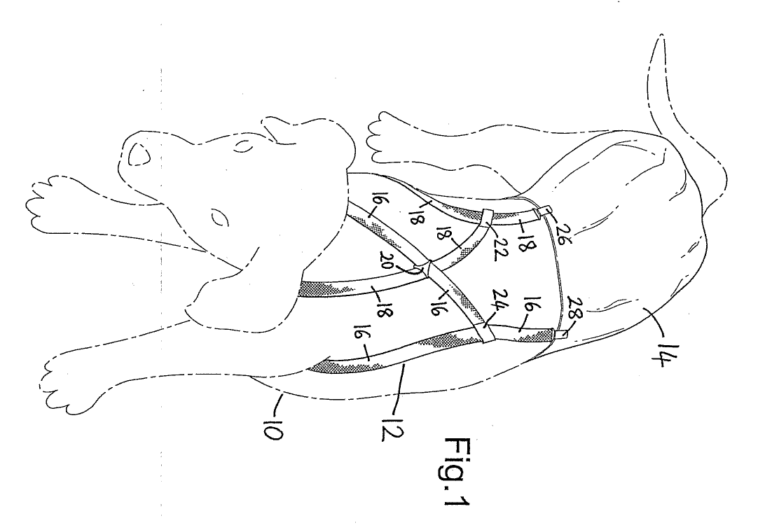

FIG. 1 illustrates a first embodiment comprising a harness attached to a dressing, shown applied to a dog, viewed from the front and above;

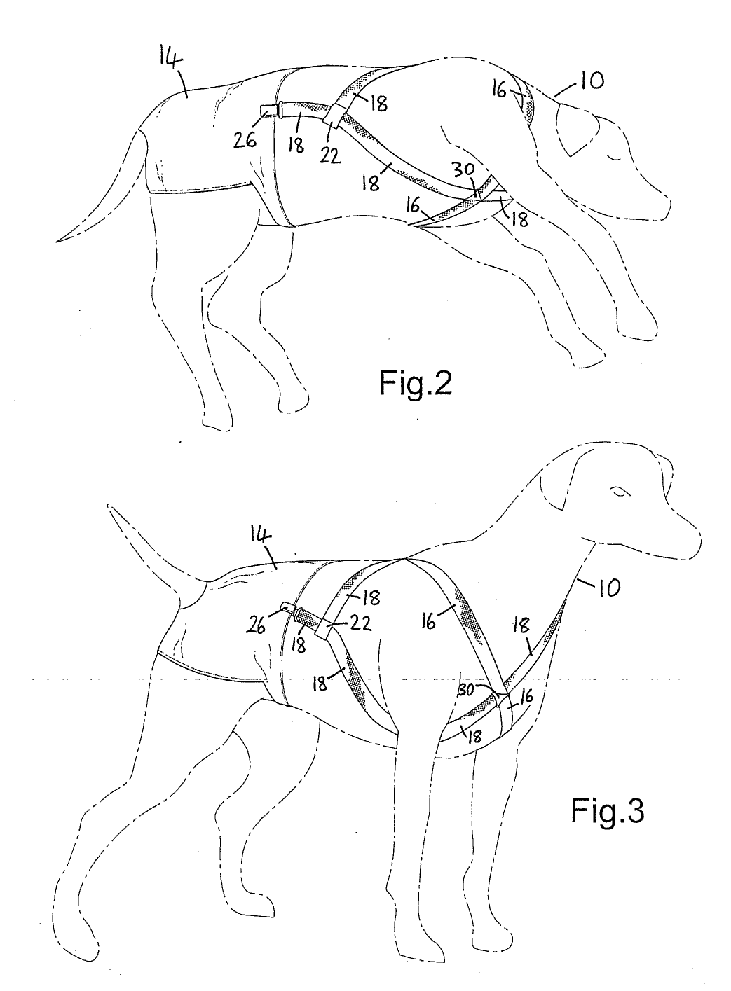

FIG. 2 shows the harness and dressing of FIG. 1, viewed from a side and below;

FIG. 3 shows another side view of the harness and dressing of FIG. 2;

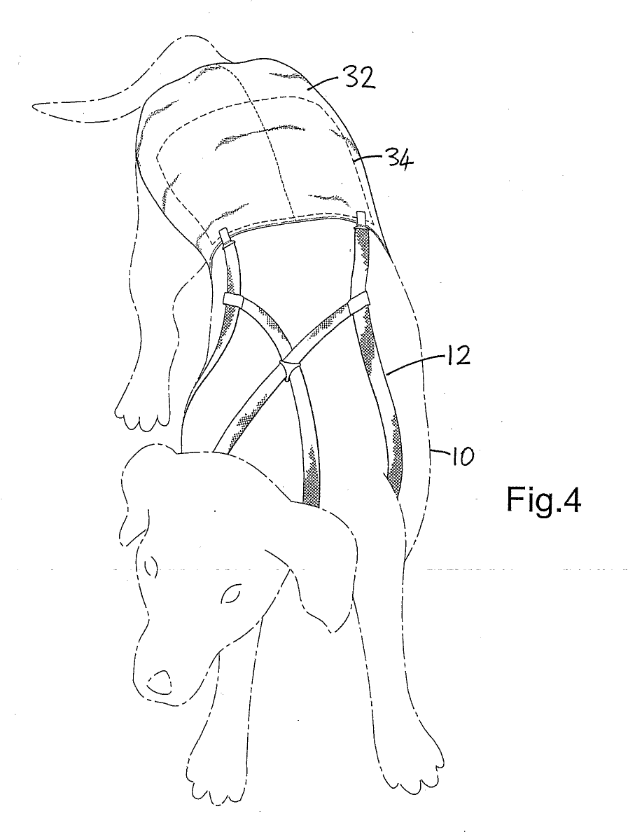

FIG. 4 illustrates a second embodiment comprising a harness attached to a cover for a dressing, shown applied to a dog, viewed from the front and above;

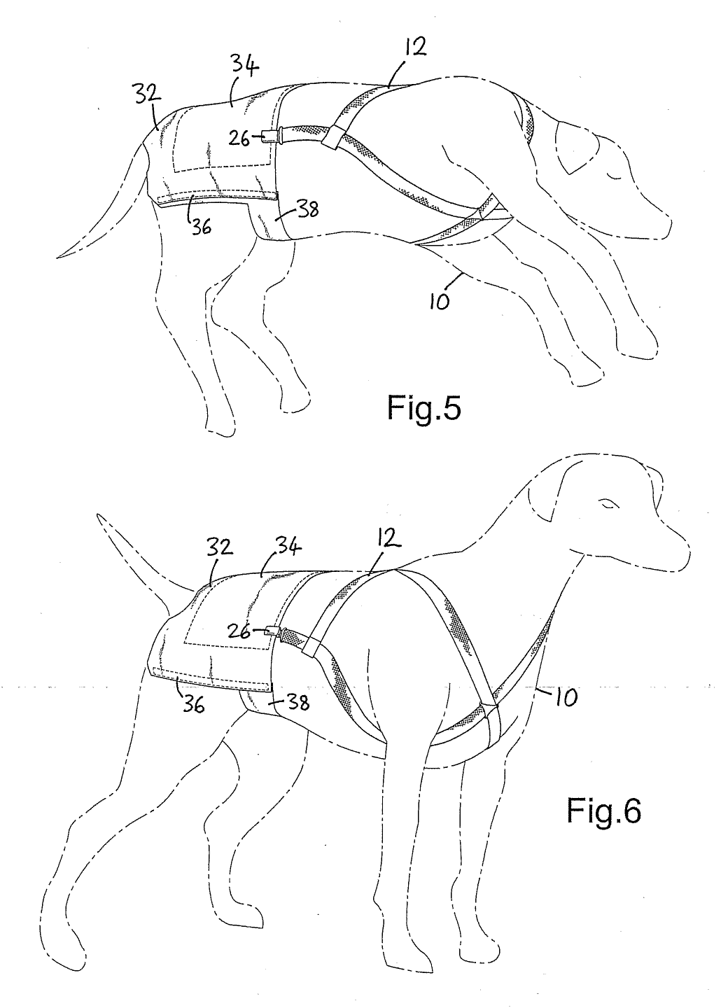

FIG. 5 shows the harness and dressing cover of FIG. 4, viewed from a side and below;

FIG. 6 shows another side view of the harness and dressing of FIG. 5;

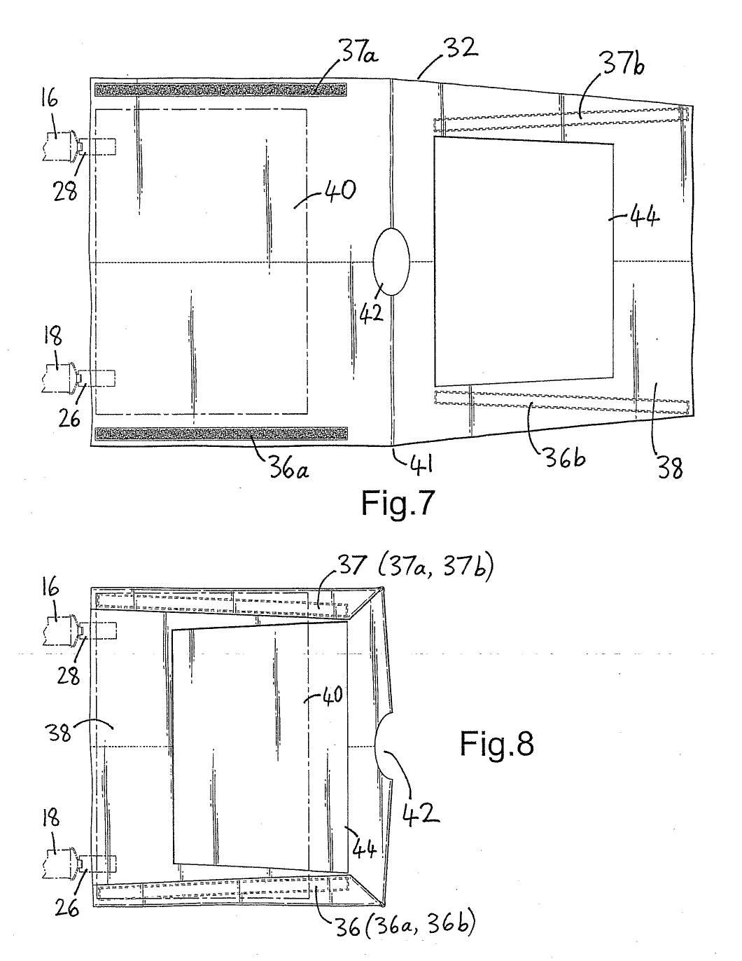

FIG. 7 illustrates the dressing cover of FIG. 4 in an open configuration;

FIG. 8 illustrates the dressing cover of FIG. 4 in a closed configuration;

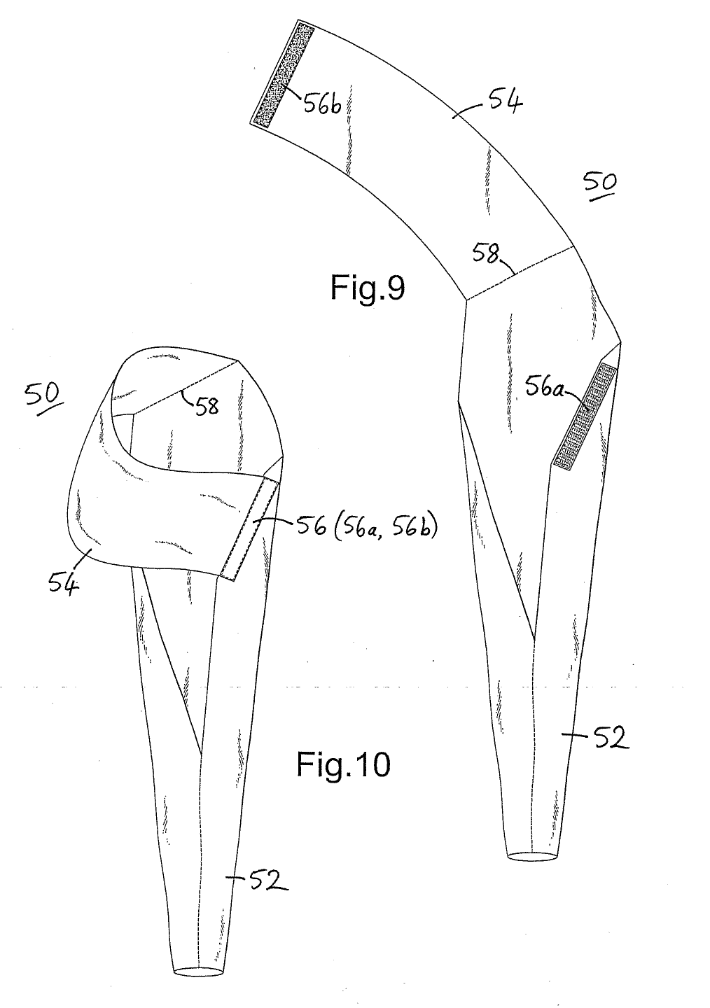

FIG. 9 illustrates a third embodiment comprising a sleeve with an integrally attached strap, the strap being unfastened from the sleeve;

FIG. 10 illustrates the sleeve and strap of FIG. 9, the strap having been fastened to the sleeve;

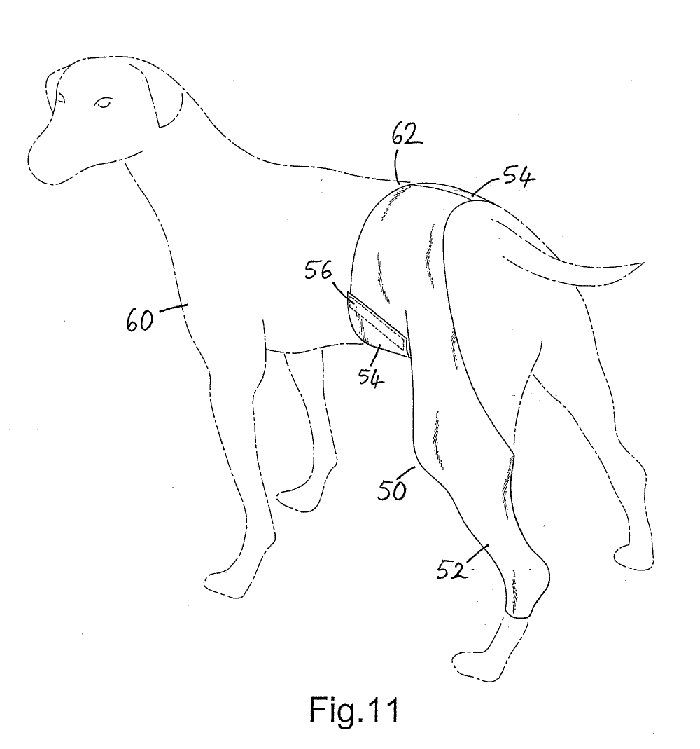

FIG. 11 shows the sleeve and strap of FIG. 9 having been applied to a dog, the sleeve having been fitted on one of the dog's hind legs and the strap having been fastened around the dog's loin;

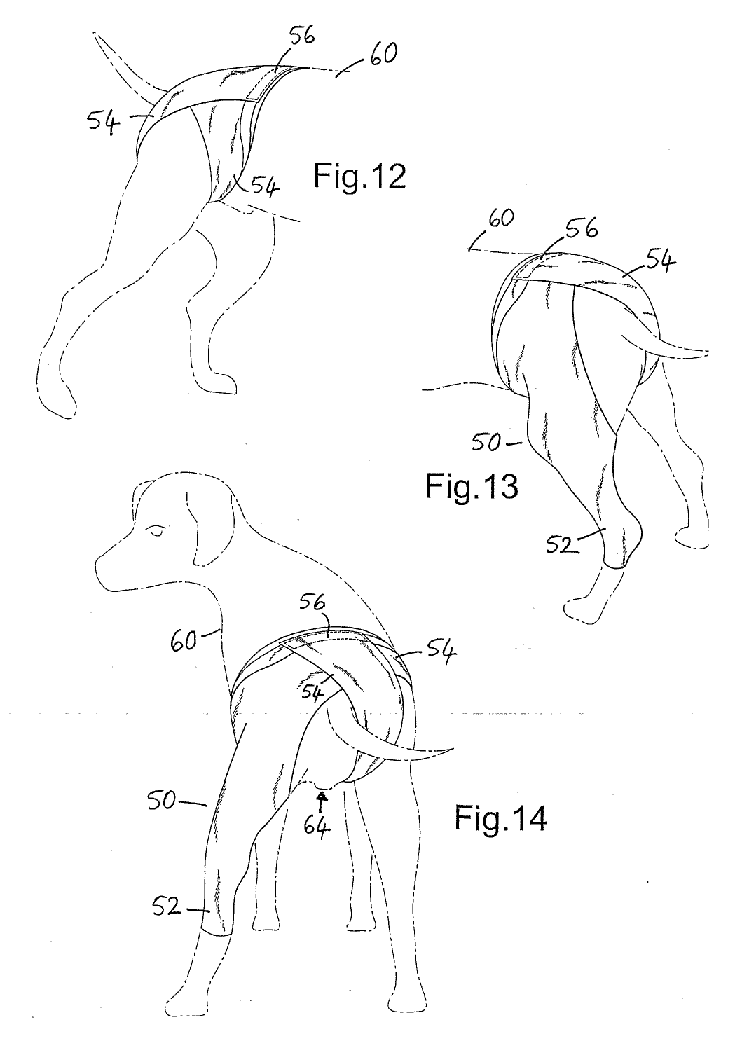

FIGS. 12, 13 and 14 also illustrate the sleeve and strap of FIG. 9 having been applied to a dog, the sleeve having been fitted on one of the dog's hind legs, but in this case the strap having been passed around the hip of the dog's other hind leg and then fastened to the sleeve, thereby leaving the dog's genitourinary region uncovered;

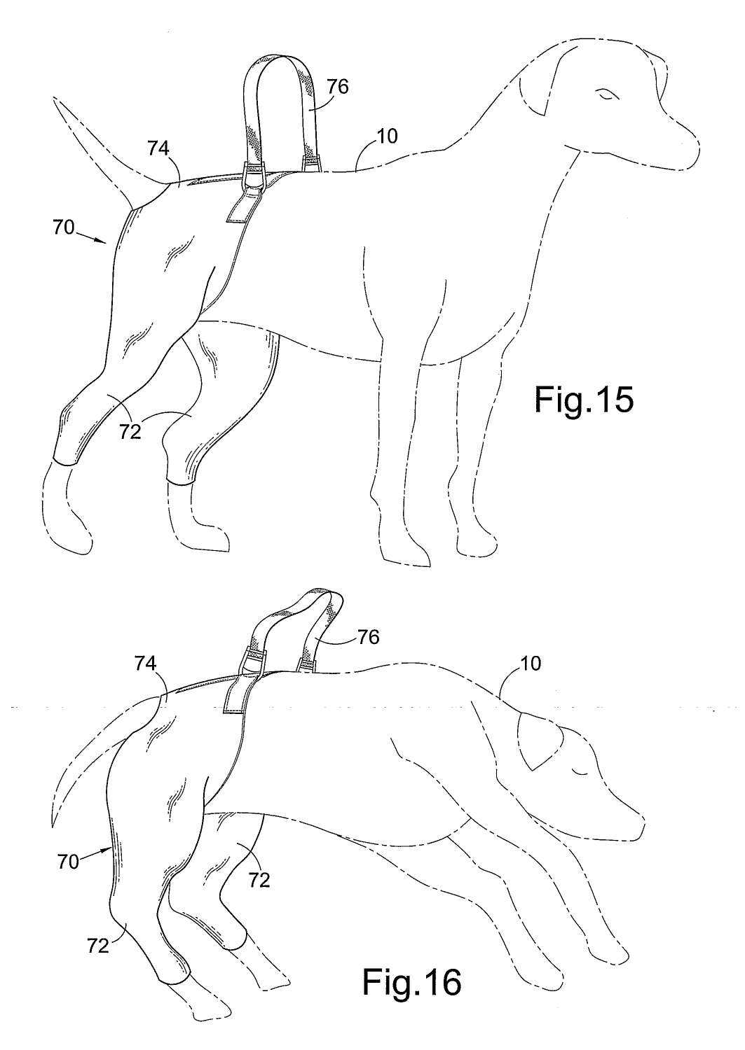

FIG. 15 illustrates a support shown applied to a dog viewed from a side;

FIG. 16 shows the support illustrated in FIG. 15 viewed from a side and below; and

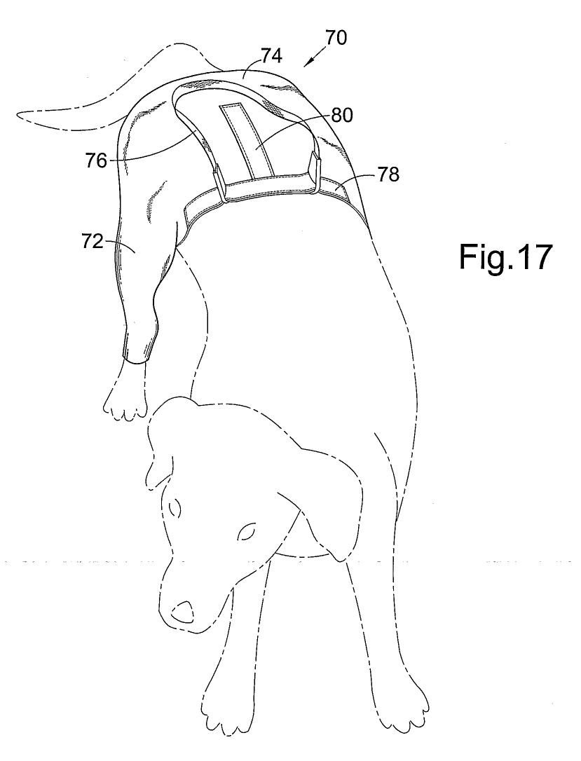

FIG. 17 shows the support illustrated in FIG. 15 viewed from the front and above.

Common reference numerals are used to designate equivalent components or features.

The present embodiments represent the best ways known to the applicant of putting the invention into practice. However they are not the only ways in which this can be achieved.

Although the present embodiments are all illustrated and described in use with dogs, it should be emphasised that they are also applicable to many other animals, such as cats and other pets, horses, zoo animals, farm animals such as cows, sheep and pigs, and other four-legged animals. The embodiments may also be used, or adapted for use, on some two-legged animals, as will be apparent to those skilled in the art. Those skilled in the art will also appreciate that the embodiments shown herein may be readily adapted for use with animals of various sizes and shapes, by straightforward design modification and dimensional scaling or resizing as appropriate. Furthermore, those skilled in the art will appreciate that the embodiments may be used for dressing or treating a wide range of animal ailments, adapting the design of the embodiments if necessary.

A first embodiment will be described with reference initially to FIGS. 1, 2 and 3, which show a dog 10 whose rump or rear back region has been wrapped or bandaged with a conventional dressing 14. Such dressings will be well known to those skilled in the art, such as veterinary surgeons.

This embodiment provides a harness 12 suitable for securing the dressing 14 on the dog 10. The harness 12 is intended to prevent the dog from readily removing the dressing 14 through fidgeting or pulling at the dressing using its teeth and legs. The harness 12 also serves to prevent (or at least impede) slippage of the dressing as a result of the natural bodily movement of the animal.

The harness 12 comprises two straps 16, 18, which are preferably made of an elasticated material, such as the material used to make men's braces (for holding up trousers). Means for adjusting the length of the straps may be provided, in a similar manner to men's braces. The harness 12 attaches directly to the dressing 14 using clips 26, 28 provided at one end of each strap 16, 18.

As shown in FIGS. 1, 2 and 3, the two straps 16, 18 are arranged to cross twice—once on the animal's back, and once on its chest region. To cause the straps 16, 18 to cross, two crossover members 20, 30 are provided. The first crossover member 20 is arranged to lie on the animal's back, and the second crossover member 30 is arranged to lie on the animal's chest.

The crossover members 20, 30 may be made of metal, or another suitable material such as a sufficiently strong plastics material, and are of the form of the crossover member often provided at the rear of men's braces.

Each crossover member 20, 30 serves to constrain the two straps 16, 18 in a crosswise configuration. The crossover members 20, 30 are preferably arranged such that the straps are gripped by the crossover members, and that sliding of the straps can only be performed by a human for adjustment purposes when fitting the straps to the animal. This prevents the straps from becoming loose, e.g. as a result of the animal's movement or fidgeting.

Each strap 16, 18 is fastened to itself at the end distal from the clips 26, 28. That is to say, the end of strap 18 distal from clip 26 is attached to the same strap 18. Likewise, the end of strap 16 distal from clip 28 is attached to the same strap 16. The straps may be attached to themselves in a variety of different ways, such as using clips or buckles, but preferably, as shown in the figures, the end of the straps are formed in loops 22, 24, with strap 18 terminating in and passing through loop 22, and strap 16 terminating in and passing through loop 24.

By virtue of the arrangement of the harness 12, and the manner in which the straps 16, 18 cross on the animal's back and cross again on the animal's chest, the dressing 14 may be securely held in place. The animal is able to move substantially unimpeded whilst wearing the dressing and harness.

In an alternative application, the dressing 14 may be an incontinence pad for an animal (or an animal nappy or diaper), which may be held in place by the harness 12.

A second embodiment will now be described with reference to FIGS. 4, 5 and 6, again being used to treat a dog that has a wounded rump or rear back region. In this embodiment, the harness 12 is exactly as described above in connection with the first embodiment.

However, in this embodiment, the harness 12 is not attached directly to the dressing, but instead is attached to a dressing cover 32 using the clips 26, 28. The dressing cover 32 is used to cover a dressing 34 (indicated by the dotted line in FIGS. 4, 5 and 6). In some cases, the wound or surgical site may be relatively small, and accordingly the dressing cover 32 may be used to hold a relatively small dressing specifically against the wound or surgical site.

The dressing cover 32 may be made of a fabric material, such as a cotton/elasticine mix, that is preferably breathable and elasticated. The fabric may also be waterproof. A range of dressing covers, made of different materials and in different sizes, may be supplied to a veterinary surgeon in order that he may choose an appropriate one to suit a specific case.

FIG. 7 illustrates the dressing cover in an open configuration. It can be seen that the dressing cover 32 is very roughly rectangular in shape, and is provided with a first region 40 for receiving the dressing to be applied to the animal. The dressing 34 may be attached in region 40 using adhesive tape (e.g. a veterinary surgeon's surgical tape, as will be readily apparent to those skilled in the art) or alternative fastening means. The dressing cover 32 is also provided with a hole or aperture 42 through which the animal's tail may pass in use, and a hole or aperture 44 through which the animal's hind legs may pass in use.

Fastening means 36, 37 are provided to enable the dressing cover 32 to be closed. For example, strips of hook-and-loop fastener material (e.g. Velcro®) 36a, 37a may be provided on one surface of the dressing cover, either side of region 40. Complementary strips of hook-and-loop fastener material 36b, 37b may be provided either side of the hole 44. It has been found that the dressing cover 32 may be closed particularly effectively if strips 36b, 37b are provided on the reverse side of the dressing cover from strips 36a, 37a.

Instead of hook-and-loop strips, alternative fastening means 36, 37 may be provided, such as zip fasteners or press studs.

The dressing cover 32 may be folded at fold line 41, which passes through (or near to) the tail hole 42. By folding the dressing cover 32, it may be closed to give the configuration as shown in FIG. 8, with strip 36a fastening with its complementary strip 36b, and strip 37a fastening with strip 37b.

In use, with the dressing cover 32 initially in its open configuration, a dressing 34 is first attached to region 40 of the cover, e.g. using adhesive tape. The harness 12 is introduced around the head and front legs of the animal and adjusted as appropriate. Then, the animal's tail is passed through hole 42 of the dressing cover 32 and the animal's legs are passed through hole 44. The cover is then folded about fold line 41, bringing the dressing 34 down onto the wounded area or surgical site on the animal's back. The fastening strips 36a and 36b, and 37a and 37b, are then fastened together. When in position on the animal, region 38 of the dressing cover acts as a kind of girth strap around the underside of the animal. The clips 26, 28 are then attached to the dressing cover 32, and the harness 12 further adjusted if necessary, thereby securing the dressing cover 32 in place.

The hole 44 may be shaped and configured such that the animal can urinate and excrete unimpeded.

The dressing cover 32 may be employed as shown in the figures, in conjunction with the harness 12, but without a dressing 34. Such an arrangement may be used if, for example, the wound no longer needs a dressing, but the veterinary surgeon wishes to prevent the animal from interfering with the healing of the wound, or to keep flies or insects off the wound.

A third embodiment will now be described with reference to FIGS. 9, 10, 11, 12, 13 and 14. This article 50 comprises a sleeve part 52 and a strap part 54, and is made of a fabric material, such as a cotton/elasticine mix, that is preferably breathable, and which may also be waterproof. The strap part 54 may be integrally formed with the sleeve part 52, as illustrated in FIGS. 9 and 10. If the strap part 54 is initially fabricated separately from the sleeve part 52, the two parts may be joined together by a stitched seam 58 during manufacture.

The sleeve 52 and strap 54 are provided with fastening means 56a, 56b, which are preferably strips of hook-and-loop fastener material (e.g. Velcro®), but which may alternatively be press studs or some other form of fastener. Thus, the strap 54 may be unfastened from the sleeve 52, as shown in FIG. 9, or fastened to the sleeve, as shown in FIG. 10.

The sleeve 52 is intended for covering a wound or surgical site on an animal's leg—such as that of a dog 60. It may be used to cover the wound or surgical site directly, or to cover a dressing applied to the wound or surgical site. It may also be used to provide surgical support to one or more joints in the animal's leg. In use, the sleeve 52 is applied to a leg, and then the strap 54 is wrapped around another part of the animal's body and then fastened to the upper part of the sleeve part using fasteners 56a, 56b, as illustrated for example in FIGS. 11, 12, 13 and 14. Once fastened, the strap 54 makes it very difficult (if not impossible) for the animal to remove the sleeve 52 from the leg, which in turn assists the healing process.

The article 50 may be applied to animals in different ways and for different purposes. For example, the sleeve 52 may be applied to the hind leg of a bitch (female dog) to cover a wound, and the strap 54 may be fastened around the animal's loin 62, as shown in FIG. 11. This fastening arrangement is suitable for a bitch, since the strap will not impede the animal's urination, but may not be suitable for a male dog since it may cover the animal's genitourinary region and thereby impede its urination.

The arrangement shown in FIG. 11 is also suitable for covering the surgical site of a cat or dog that has just been spayed, but reversing the function of the sleeve and strap parts. In such a case, the strap part 54 covers the surgical site (where the animal has been spayed), and the sleeve part 52 on the leg serves to secure the strap part in place. This reverses the functions of the sleeve and strap parts when compared with the example of covering a leg wound. However, it will be appreciated that in both the leg-wound example and the spaying example, one part of the article 50 is used to cover the wound or surgical site, and the other part is fastened around another part of the animal's body in order to secure the first part in place.

For covering a wound on a hind leg of a male dog, the strap part may be wrapped in the manner illustrated in FIGS. 12, 13 and 14. As shown in these figures, the sleeve 52 is first applied to one hind leg, and then the strap 54 is passed around the hip of the dog's other hind leg and then fastened to the top of the sleeve part, thereby leaving the dog's genitourinary region 64 uncovered and unimpeding the animal's urination.

When fitting the sleeve 52 to the front leg of an animal, the strap 54 may either be fastened around the animal's back (in a similar manner to that as illustrated in FIG. 11) or may be fastened around the hip of the opposing front leg (in a similar manner to that as shown in FIGS. 12, 13 and 14).

Other ways of fitting the sleeve 52, and of wrapping and fastening the strap part 54 around an animal, are also possible—depending on the anatomy of the animal, the position of the wound or surgical site, and the nature of the animal's ailment—as will be appreciated by those skilled in the art, such as veterinary surgeons.

If an animal to which the article 50 has been fitted is particularly fidgety, then a harness 12 (as described above with reference to FIGS. 1 to 6) may also be fitted around the animal and attached to the article 50. That is, the harness 12 may be used in addition to the strap 54, to further enhance the degree to which the sleeve 52 is secured on the animal, thereby further impeding the animal's ability to remove the sleeve 52.

If the animal 10 is unable to support its weight then, in addition to a dressing it may be provided with support 70 as illustrated in FIG. 15. Although the support 70 is illustrated using the back legs of an animal 10 in FIG. 15 it will be understood that the support 70 may equally be applied to any pair of legs of an animal 10. The support 70 is has two holes, a connector 74 and a strap part 76. The connector 74 and strap part 76 may be integrally formed or fabricated separately and then joined together, for example by use of a stitched seam.

Each hole is adapted to allow one of a pair of legs of an animal 10 to pass through. Additionally, each hole may be in communication with a sleeve part 72, as shown in FIG. 15. The sleeve part 72 may be integrally formed with the connector 74 and strap part 76. Alternatively it may be fabricated separately and then joined to the connector 74, for example by use of a stitched seam.

The connector 74 is preferably situated over the back of the animal with none of the support extending underneath the animal as illustrated in FIG. 16. This means that when the support 70 is used to hold the weight of the animal minimal pressure is exerted on the groin and no pressure is exerted on the bladder area of the animal 10 thereby minimising any discomfort caused by the support 70.

The connector 74 is provided with a strap 76. The strap 76 may be integral to the connector 74 or attached to the connector 74 by use of a stitched seam and is preferably adjustable. Alternatively, the strap 76 may be removably attached to the connector 74, for example clips on either end of the strap may attach to the connector 74 at attachment points. Attachment points may be part of the connector 74 as illustrated or provided on the connector 74. For example the attachment point may be on a clip attached to the connector 74. In its simplest implementation the strap 76 is provided as a single loop which encircles the connector 74.

When a user needs to aid the animal in supporting its weight the user can hold the strap and exert an upward force on it. The upward force on the strap causes the sleeve parts, and consequently the animal's legs to be raised.

The connector 74 may be provided with guides 78, 80, such as those shown in FIG. 17. The guides 78, 80 may be, for example first and second portions that are perpendicular to each other. The two portions 78, 80 may both be attached to the connector 74, for example by sewing. Alternatively, one portion may extend in a loop around the connector 74 and be attached to the other portion in order to prevent movement (not shown). The first portion 78 preferably attaches to the second portion 80 at a point that bisects the second portion. This provides two points of attachment for the strap 76.

The sleeves and connector are preferably made from a fabric material, such as a cotton/elasticine mix, that is preferably breathable and which may also be waterproof. The support may be used in the presence of a dressing for a wound. The dressing may be separate from the support but covered by it, such as the dressing illustrated in FIG. 1, or the dressing may be integral to the support.

Additionally, the support is provided with padding at the edges of the support in order to reduce any rubbing of the support against an animals skin. The padding may be, for example, foam, fleece material or any other suitable type of material.

1. Apparatus for use in dressing a wound or surgical site on an animal, said apparatus comprising:
a cover part for covering the wound or surgical site; and
a harness comprising one or more straps that are integral with or attachable to the cover part and which are adapted to be secured around another part of the animal's body, the straps being provided with crossover members through which the one or more straps pass.

2. Apparatus as claimed in claim 1, wherein the cover part is a dressing.

3. Apparatus as Claimed in claim 1, wherein the cover part is a cover for a dressing.

4. Apparatus as claimed in claim 3, wherein the cover for the dressing comprises a first region for receiving a dressing and a first hole for one or more of the animal's legs to pass through.

5. Apparatus as claimed in claim 4, wherein the cover for the dressing is made of a textile material.

6. Apparatus as claimed in claim 4, wherein the cover for the dressing is manipulable from an open configuration in which a dressing may be introduced to the first region and in which the first hole is to one side of the first region, to a closed configuration in which the first region overlaps the first hole.

7. Apparatus as claimed in claim 6, wherein the cover for the dressing further comprises one or more fasteners for securing the cover in the closed configuration.

8. Apparatus as claimed in claim 7, wherein the fasteners comprise one or more strips of hook-and-loop fasteners.

9. Apparatus as claimed in claim 6, wherein the cover for the dressing incorporates a fold line about which the cover may be folded from the open configuration to the closed configuration.

10. Apparatus as claimed in claim 4, further comprising a second hole for the animal's tail to pass through.

11. Apparatus as claimed in claim 9, further comprising a second hole for the animal's tail to pass through and the fold line passes through or close to the second hole.

12. Apparatus as claimed in claim 3, wherein the cover for the dressing is adapted to hold the dressing on the rear part of the animal's back.

13. Apparatus as claimed in claim 1, comprising two straps.

14. Apparatus as claimed in claim 13, wherein a first end of each strap is provided with fastening means for attachment to the cover part.

15. Apparatus as claimed in claim 14, wherein the fastening means are clips.

16. Apparatus as claimed in claim 13, wherein a second end of each strap is provided with attachment means for attaching said end to said strap.

17. Apparatus as claimed in claim 16, wherein the attachment means comprises a loop formed in the end of the strap.

18. Apparatus as claimed in claim 13, wherein the straps are configured to pass between the animal's front legs and over the animal's back, and thereby secure the cover part on the rear part of the animal's back.

19. Apparatus as claimed in claim 1, wherein the said straps are elasticated.

20. Apparatus as claimed in claim 1, wherein the cover part comprises a sleeve.

21. Apparatus as claimed in claim 20, comprising a single strap.

22. Apparatus as claimed in claim 21, wherein the strap is integral with the sleeve.

23. Apparatus as claimed in claim 22, wherein the end of the strap distal from the sleeve is provided with fastening means.

24. Apparatus as claimed in claim 23, wherein the cover part is provided with fastening means adapted to fasten with the fastening means provided on the distal end of the strap.

25. Apparatus as claimed in claim 20 made of a textile material.

26. Apparatus as claimed in claim 25, wherein the textile material is elasticated.

27. A cover adapted for use on an animal with the dressing as claimed in claim 1, the cover comprising a first region for receiving a dressing and a first hole for one or more of the animal's legs to pass through.

28. A cover as claimed in claim 27 wherein the cover contains a dressing.

29. A harness for securing a dressing or a cover for a dressing to an animal's body as recited in claim 1.

30. A support for use with the apparatus of claim 1 comprising:
two holes, each hole arranged to allow a leg of an animal to pass through;
a connecting region for attaching the two cover parts together; and
a strap attached to the connecting region for enabling a user to support at least part of the weight of the animal.

31. A support as claimed in claim 30 wherein the support further comprises one or more attachment means to which the strap removably attaches.

32. A support as claimed in claim 31 wherein the attachment means comprises a pair of guides situated such that the attachment means are at least a predetermined distance apart.

33. A support as claimed in claim 30, wherein each hole is aligned with a hole in a sleeve, the sleeve comprising a first region for contacting a leg.

34. A support as claimed in claim 33 wherein the sleeves are integral to the connecting region.

35. A support as claimed in claim 33 wherein the sleeves and connecting region are provided with padding around their edges.

36. A support for an animal comprising:
two holes, each hole arranged to allow a leg of an animal to pass through;
a connecting region for attaching the two cover parts together; and
a strap attached to the connecting region for enabling a user to support at least part of the weight of the animal.

37. A method of covering a wound or surgical site on an animal, said method comprising:
applying a cover to the wound or surgical site; and
fastening one or more straps around another part of the animal's body, said one or more straps being attached to the cover and being provided with a crossover member through which the one or more straps pass.

38. (canceled)

39. (canceled)
